(19) United States
(12) Patent Application Publication
(10) Pub. No.: US 2007/0198186 A1
(43) Pub. Date: Aug. 23, 2007

(54) Method and apparatus for controlling transportation, storage and sale of fluids such as petrochemicals

(75) Inventors: John Realini, Belvidere, IL (US); Jerald Cayo, Belvidere, IL (US)

Correspondence Address: REINHART BOERNER VAN DEUREN P.C., 2215 PERRYGREEN WAY, ROCKFORD, IL, 61107, US

(73) Assignee: Tranzilient, LLC, Loves Park, IL (US)

(21) Appl. No.: 11/700,712

(22) Filed: Jan. 30, 2007

Related U.S. Application Data
(60) Provisional application No. 60/764,176, filed on Feb. 1, 2006.

(51) Int. Cl. G01C 21/00

(52) U.S. Cl. 701/213

(57) ABSTRACT

Methods and apparatuses are provided, for use singlely, or as part of a comprehensive security solution, for ensuring the integrity of a supply chain involving transportation, storage and/or sale of fluids such as petrochemicals. Passage of a fluid through an opening in an otherwise closed fluid tank is controlled by locking the opening against passage of fluid therethrough until a signal derived from a GPS is received, indicating that the tank is positioned at a pre-determined location whereat the opening in the tank is to be unlocked for allowing passage therethrough of the fluid. The tank may be, inter alia, a mobile tank, a stationary tank at a bulk station, or a stationary tank at a service station.

### CROSS-REFERENCE TO RELATED PATENT APPLICATIONS

This patent application claims the benefit of U.S. Provisional Patent Application No. 60/764,176, filed Feb. 1, 2006, the disclosure and teachings of which are incorporated herein in their entireties, by reference.

### FIELD OF THE INVENTION

This invention relates to transportation, storage and sale of fluids such as petrochemicals, and more particularly to providing security measures at various strategic points in a supply chain for precluding theft, and/or other unauthorized or unintentional transfers of fluid during transportation, storage and sale of the fluid.

### BACKGROUND OF THE INVENTION

It is highly desirable to provide a comprehensive security solution ensuring the integrity of transportation, storage and sale of fluids such as petrochemicals, along a supply chain from a trusted point of origin to consumer distribution centers. Prior approaches to providing such a comprehensive security solution have proven inadequate, allowing a multitude of opportunities for intentional theft of the product being delivered, and/or unintentional mistakes being made at various points in the supply chain resulting in a reduction in efficiency and effectiveness of the supply chain, and the generation of additional cost which must be either absorbed by the supplier or passed on to the consumer.

Previous approaches have generally not provided a comprehensive security solution, but have relied upon stand-alone measures applied at various points in the supply chain. Such approaches have generally not been effective, and have often resulted in considerable additional cost being generated during the supply-chain process. It is desirable, therefore, that improved security methods and apparatuses be provided which can operate in an integrated manner as part of the comprehensive security solution which not only provides enhanced security, but does so at a lower cost than prior approaches.

In a supply chain extending from a bulk fuel terminal to a consumer service station, for example, it is necessary to ensure that fuel being transported from the bulk terminal to the service station by mobile tank trucks does, in fact, reach the desired service station, and can only be dispensed at that service station, to preclude the possibility that the fuel would be discharged partially or completely from the truck at another location. It is also desirable, in some circumstances, to ensure that only trucks having authorization to fill at a particular bulk terminal and discharge at particular service stations can do so. Such circumstances may arise, for example, where a governmental entity controls the entire supply chain, and collects taxes on the basis of how much fuel is delivered to a particular service station. If the service station could also receive fuel from an unauthorized tank truck, the governmental goal of collecting taxes on all fuel sold at that station might be thwarted.

Another example illustrating the need for the present invention, is provided by bulk stations providing a particular blend of fuel to service stations licensed or otherwise authorized to sell that particular brand or blend of fuel. Without a comprehensive security provision being available, the specially blended fuel might inadvertently or purposefully be diverted for sale at other retail outlets not licensed to sell that particular blend or brand of fuel.

### BRIEF SUMMARY OF THE INVENTION

The invention provides improved methods and apparatuses which may be used singlely, or as part of a comprehensive security solution ensuring the integrity of a supply chain involving transportation, storage and/or sale of fluids such as petrochemicals.

In one form of the invention, passage of a fluid through an opening in an otherwise closed fluid tank is controlled by locking the opening against passage of fluid therethrough until a signal derived from a Global Positioning System (GPS) is received, indicating that the tank is positioned at a pre-determined location whereat the opening in the tank is to be unlocked for allowing passage therethrough of a fluid. In various embodiments of the invention, the tank may be a mobile tank, a stationary tank at a bulk station, or a stationary tank at a service station.

Some forms of the invention may further include reporting any transfer of fluid through the opening to a network operating center. Any locking or unlocking of the opening may also be reported to a network operating center.

The invention may further include using a motor-driven actuator for locking and unlocking the opening in the tank. The tank may include the motor-driven actuator.

The tank may be a mobile tank, movable from a first location at which an unlocked location designation signal input is received, designating the pre-determined location at which the opening is to be unlocked when a location verification signal derived from the GPS is received at the tank verifying that the mobile tank is located at the pre-determined location. Where the first location is a fluid terminal, the invention may further include an exchange of additional security codes between the terminal and the mobile tank verifying that the terminal and mobile tank are authorized to exchange fluid with one another. Where the terminal is a supply terminal, it may be the only location at which the unlock designation signal to the mobile tank can be modified. The supply terminal may also be designated as the only location at which the unlock designation signal can be overridden. Having the supply terminal be the only point at which the unlock designation signal can be modified or overridden illustrates a philosophy governing some embodiments of the invention that the only trustworthy entity is the point of origin, i.e. the supply terminal, and that all other variables in the supply chain could be compromised and are therefore considered to be untrustworthy.

Where the second tank also has a lockable opening therein, and is located at the pre-determined location whereat the opening in the mobile tank can be unlocked, the invention may further include unlocking the lockable opening in the second tank with a proximity unlock signal from the mobile tank, with the proximity unlock signal being supplied only when the mobile tank is located proximate to the second tank at the pre-determined location as verified by the GPS system. Power for unlocking the opening in the second tank may be supplied by the mobile tank, through a power cable connected between the mobile tank and the lock in the second tank. The proximity unlock signal may be provided across an inductive link in the power cable. In other embodiments of the invention, the proximity unlock signal may be provided in other appropriate ways, such as through a wireless communication link, or across a separate signal cable.

Where a second tank, also having a lockable opening therein, is located at the pre-determined location or at the opening in the mobile tank can be unlocked, the invention may further include an exchange of an operator identification signal at the second tank, verifying that the operator is authorized to transfer fluid between the mobile tank and second tank. The operator may, for example, be a person transporting the mobile tank to the second tank. Such a person might be the driver, for example, of a tank truck being used for transporting the mobile tank. The invention thus provides protection against hijacking of the truck, or other unauthorized persons being involved in the process of transporting and transferring fluid between the mobile tank and second tank, or vice versa.

In some forms of the invention, additional exchanges of identification signals may also be provided for between the mobile tank and a device used for transporting the mobile tank, to ensure that only authorized combinations of the mobile tank, the transportation device, and operator are utilized in the supply chain. Such a provision may be incorporated in embodiments of the invention where a semi-tractor trailer combination is utilized, for example, to transport the mobile tank. Such provisions may also be advantageous, for example, in situations where the mobile tank is a tank car transported by locomotive, or is loaded onto a truck, barge, or ship for transportation.

The invention may take the form of an apparatus for controlling transfer of fluids between a first tank and a second tank, when the second take is located at a predetermined fluid exchange location verified by receipt of a signal from a global positioning satellite (GPS). Such an apparatus may include, a lockable fluid control valve, a first control transceiver and a second control transceiver. The lockable fluid control valve may be adapted for connection to one or the other of the first and second tanks, and configured for allowing fluid flow therethrough when in an unlocked state thereof, and for blocking fluid flow therethrough when in a locked state thereof.

The first control transceiver may be adapted for attachment to the first tank and be programmable for receiving and verifying an identification code of the second control transceiver. The first control transceiver is also adapted for sending an identification code of the first control transceiver, and for sending a verification signal to the second control transceiver upon verification of the identification code of the second control transceiver.

The second control transceiver may be adapted for attachment to the second tank and be programmable, for sending an identification code of the second control transceiver to the first control transceiver, and, for receiving and verifying the identification code of the first control transceiver. The second control transceiver may be further programmable for recording a desired fluid exchange GPS location, at which the second tank is allowed to exchange fluid with the first tank. The second control transceiver may also be configured for receiving a GPS signal from a source independent from the first and second control transceivers, with the GPS signal being indicative of a present location of the second control transceiver, and for verifying that the present control location of the second tank, as determined from the received GPS signal, matches the desired fluid exchange location.

The second control transceiver may be further configured and operatively connected to the lockable fluid valve for sending an unlocking signal to the lockable fluid valve, only upon completion of a successful mutual exchange between, and mutual verification of, the programmed identification codes of the first and second transceivers, together with receipt and verification by the second control transceiver that the present GPS location of the second tank matches the programmed fluid exchange location of the second tank.

An apparatus, according to the invention, may further include a network operation center (NOC), which is remotely locatable from the first and second control transceivers, and configured for providing the first and second control transceiver identification codes to the first and second control transceivers. In some forms of the invention, at least one of the first and second control transceivers may be further configured for reporting the amount of fluid transferred to the NOC.

A second control transceiver, according to the invention, may be configured for recording a GPS location of any transfer, or attempted transfer, to and/or from the second tank. The second control transceiver may also be configured for reporting in the NOC a GPS location of any transfer or attempted transfer to and/or from the second tank.

An apparatus, according to the invention, may include multiple first tanks, each having a given first control transceiver operatively attached thereto. In such embodiments of the invention, the second control transceiver may be programmable, for sending the identification code of the second control transceiver to each of the multiple first control transceivers, and, for receiving and verifying an identification code of each of the multiple first control transceivers. The first control transceiver may also be programmable for recording multiple desired fluid exchange GPS locations, at which the second tank is allowed to exchange fluid with one or more of the multiple first tanks. The second control transceiver may also be configured for receiving a GPS signal from a source independent from the first and second control transceivers indicative of a present location of the second control transceiver, and may be further configured for verifying that the present location of the second tank, as determined from the received GPS signal, matches the desired fluid location of a given one of the multiple first tanks.

The second control transceiver may be further configured and operatively connected to the lockable fluid valve, for sending an unlocking signal to the lockable fluid valve of a given one of the first tanks at the given fluid exchange position of that one of the first tanks, only upon completion of a successful mutual exchange between, and mutual verification of, the programmed identification codes of the given one of the first control transceivers with the second control transceiver at the given fluid exchange location for that one of the first tanks, and receipt and verification by the second control transceiver that the present GPS location of the second tank matches the programmed fluid exchange location of the second tank for the given one of the multiple first tanks.

In some forms of the invention, the second control transceiver may be further configured for monitoring a GPS signal, and re-locking the lockable fluid control valve when the second control transceiver has moved outside of a pre-determined control radius of the fluid exchange location.

In some forms of the invention, a first lockable fluid control valve is operatively attached to a first control receiver, according to the invention, and a second lockable control valve is operatively attached to the second control transceiver, with neither the first nor the second fluid control valve being unlocked until the mutual exchange and verification of identification codes and GPS verification of the location of the second tank at a fluid exchange position has been completed.

In an apparatus, according to the invention, wherein the fluid control valve is electrically actuated, and at least one of the first and second tanks is moveable with respect to the other, one of the first and second tanks may include a common electrical power source for both of the first and second control transceivers and the electrically actuated fluid control valve.

The invention may be practiced in many forms, including as a method, a business method, an apparatus, or as a computer program having executable instructions stored on a computer readable medium for performing the steps of a method in accordance with the invention.

Other aspects, objects and advantages of the invention will be apparent from the following description when taken in conjunction with the accompanying drawings and attachments.

### BRIEF DESCRIPTION OF THE DRAWINGS AND ATTACHMENTS

The accompanying drawings and attachments, incorporated into and forming a part of the specification, illustrate several aspects of the present invention and, together with the description, serve to explain the principles of the invention. In the drawings:

FIG. 1 is a schematic illustration of elements of an exemplary embodiment of the invention located at a first location in the form of a supply terminal;

FIG. 2 is a schematic illustration of elements of the exemplary embodiment of the invention located at a pre-determined second location, in the form of a service station;

FIG. 3 is a schematic representation of a lockable fluid control valve, including an electric actuator and an electrically actuated valve locking device, in accordance with the invention.

While the invention will be described in connection with certain preferred embodiments, there is no intent to limit it to those embodiments. On the contrary, the intent is to cover all alternatives, modifications and equivalents as included within the spirit and scope of the invention.

### DETAILED DESCRIPTION OF THE INVENTION

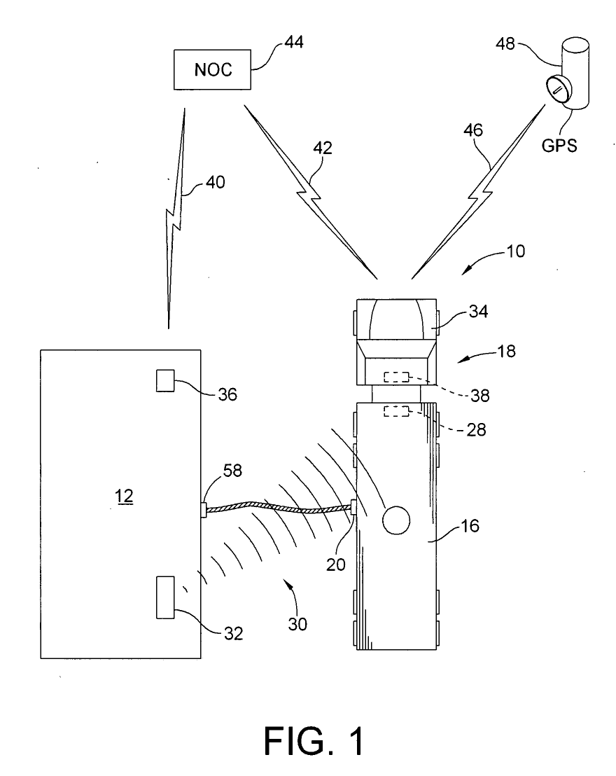

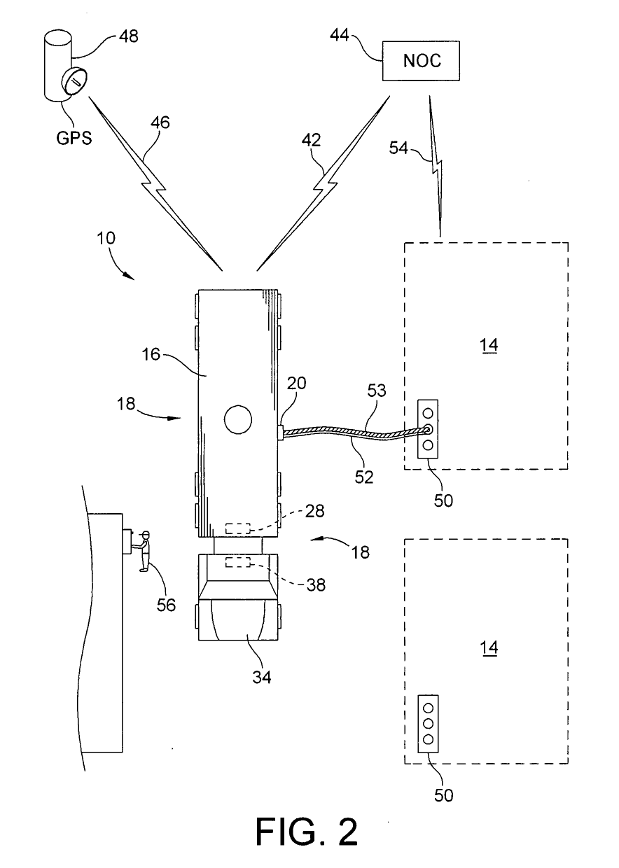

FIGS. 1 and 2 show an exemplary embodiment of a method and apparatus 10, according to the invention which provides a comprehensive security solution ensuring the integrity of a supply chain involving transportation, storage and/or sale of a petrochemical, such as gasoline from supply terminal 12 to one or more consumer service stations 14. FIG. 1 shows a mobile tank 16, specifically a trailer of a tractor trailer rig 18, located at a first location of the mobile tank 16 adjacent the supply terminal 12. FIG. 2 shows the same tanker truck 18 at a pre-determined second location proximate to an underground storage tank of the service station 14.

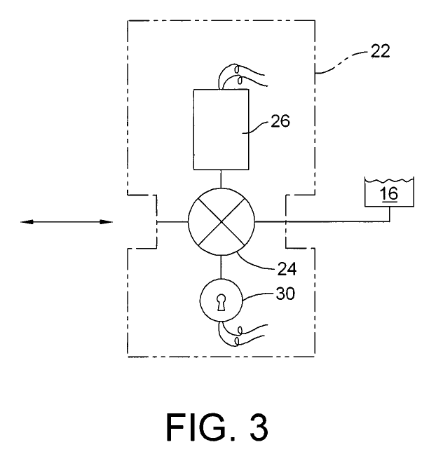

The mobile tank 16 includes a lockable fill-drain opening 20 in an otherwise substantially closed tank. As used herein, the term “substantially closed,” means closed to normal fluid traffic, though the tank may be vented, for example. As shown in FIG. 3, in the exemplary embodiment of the invention 100, the lockable fill-drain opening 20, in the mobile tank 16, of the tractor-trailer rig 18 includes an electric motor actuated, and electrically lockable, fluid control valve 22, as shown schematically in FIG. 3. The lockable fluid control valve 22, of the exemplary embodiment, includes a valve element 24, which may be selectively opened and closed to alternatively allow, or block, fluid flow into or out of the mobile tank 16. The valve element 24 is controlled by an electric actuator 26, which is operatively connected to a mobile tank control transceiver 28, which sends commands to the electric actuator 26 for opening and closing the valve element 24, in accordance with the invention, in a manner to be described in greater detail below. As further shown in FIG. 3, the lockable fluid control valve 22 also includes an electrically controlled locking device 30, which is operatively connected to the mobile tank control transceiver 28 controlling locking and unlocking of the valve 22, in accordance with the invention, in a manner described in greater detail below.

As shown in FIG. 1, when the mobile tank 16 is located at the supply terminal 12, an unlocked location designation signal 30 is supplied to the mobile tank 16 from a transmitter 32 of a control transceiver at the supply terminal 12. In various embodiments of the invention, the mobile tank 16 and/or the tractor 34 of the tractor trailer rig 18 may include a master control module 34 for receiving and processing the unlock designation signal 30, and for receiving and generating various other types of identification and data signals utilized in practicing the invention. It will be further understood, that although the unlock designation signal 32 is illustrated, in FIG. 1, as being transmitted wirelessly, the signal 32 may be transmitted by any appropriate means.

As shown in FIG. 1, in the exemplary embodiment 10 of the invention, the supply terminal 12 and both the tractor 34 and trailer 16 of the tractor trailer rig 18 include ID modules 36, 38, 34 which may communicate with each other wirelessly or by other appropriate means to verify that a particular desired combination of tractor trailer rig 18 and supply terminal 12 are present, such that only tractor trailer rigs 18 authorized to fill at that particular supply terminal 12 may receive fuel and the unlocked designation signal 32 from that supply terminal 12. In the exemplary embodiment 100, the supply terminal 12 is the only location at which the unlock designation signal 32 to the mobile tank 16 may be modified or overridden. The limited override function is provided, in case it becomes necessary to reprogram or correct an error in filling of the mobile tank 16 while it is still located at the supply terminal 12.

FIG. 1 also schematically illustrates, by symbols 40, 42 that both the supply terminal 12 and mobile tank 16 include the capability for transmitting information relating to any transfer of fluid through the opening 20 to a network operating center (NOC) 44, in addition to a signal indicating locking or unlocking of the opening in the mobile tank 16. In this manner, the NOC 44 can track the transfer of a desired number of gallons of fuel, for example, and detect any unauthorized attempts to unlock the opening 20 in the mobile tank 16.

It will be noted by those having skill in the art, that in the mobile tank 16 of FIG. 1, a single opening 20 is illustrated for use both in filling and draining the mobile tank 16. It is contemplated that in other embodiments of the invention, wherein a mobile truck 16 may have separate openings 20 for filling and draining the tank 16, that both the fill and drain openings 20 would be lockable, in accordance with the invention, with the fill opening being capable of being unlocked only at a supply terminal, and the drain opening being capable of being unlocked only at the service station 14, for example, or another pre-determined location at which it is desired to dispense fuel from the mobile tank 16.

In the exemplary embodiment, passage of fluid through the opening 20 in the mobile tank 16 is controlled using the lockable fluid control valve 22, by locking the opening 20 against passage of fluid therethrough until a signal 46 derived from a global positioning system (GPS) 48 is received, indicating that the mobile tank 16 is positioned at a pre-determined location whereat the opening 20 in the tank 16 is to be unlocked for allowing passage therethrough of the fluid. Accordingly, the unlock designation signal input 32 from the supply terminal 12 includes a designation of the pre-determined, desired fluid exchange location, at which the opening 20 is to be unlocked, when a present location verification signal derived from the GPS signal 46 is received at the tank 16, as illustrated in FIG. 2, verifying that the mobile tank 16 is located at the pre-determined fluid exchange location.

As shown in FIG. 2, in the exemplary embodiment of the invention, the underground tank 14 at the service station 14 also has a lockable opening 50 therein, equipped with a lockable fluid control valve similar to the valve 22 described above, with the underground tank 14 being located at a pre-determined fluid exchange location whereat the opening 20 in the mobile tank 16 can be unlocked. The lockable opening 50 in the underground tank 14 is unlocked when a proximity unlock signal is received from the mobile tank 16, with the proximity unlock signal being capable of being supplied only when the mobile tank 16 is located proximate to the underground tank 14 at the pre-determined location as verified by the GPS system 48.

In the exemplary embodiment 10, power for unlocking the opening in the underground tank 14 is supplied from the mobile tank 16, through a power cable 52 connected between the mobile tank 16 and the lockable fluid control valve 22 at the opening 50 of the underground tank 14. The proximity unlock signal in the exemplary embodiment is supplied across an inductively coupled link, as is known in the art, in the power cable 52, in order to provide an enhanced level of security. By this method, it is not possible to open the lock on the opening 50 in the underground tank 14 by simply attaching an electrical power to the lockable fluid control valve at the opening 50 of the underground tank 14. It will be understood that, in other embodiments of the invention, the proximity unlock signal may be provided in other appropriate ways, such as through a short-range wireless communication link, or across a separate signal cable.

As illustrated in FIG. 2, by the symbols 42 and 54, the tractor trailer rig 18 and underground tank 14 of the exemplary embodiment 10, also include the capability for transmitting data relating to fluid transfer and locking and unlocking of the lockable openings 20, 50 on the mobile tank 16 and underground tank 14 to a network operation center 44 providing overall coordination and additional security.

As shown in FIG. 2, the exemplary embodiment of the invention also further includes provisions for an exchange of an operator identification signal at the service station 14, i.e. at the location of the underground tank 14, for verifying that the operator 56 desiring to transfer fluid between the mobile tank 16 and the underground tank 14 is authorized to do so. The operator 56 may, for example, be a driver of the tractor trailer rig 18. Identification of the operator 56 may include biometric methods, such as retinal scans, or thumb prints, or other appropriate means requiring entry of password codes or use of an access card.

From the foregoing description, those having skill in the art will recognize that, according to one form of the invention, a method for transferring a large quantity of fuel (10,000+, for example, gallons) from the supply terminal 12 to one or more service stations 14 with the tractor trailer rig 18 might take place according to the following steps.

As the mobile tank 16 is pulled into proximity with the stationary tank at the supply terminal 12, the supply terminal control transceiver, represented by the transmitter 32 and the first control transceiver 36 in FIG. 1, senses the approach of the mobile tank control transceiver 28, attached to the mobile tank 16, and initiates an exchange of identification codes between the mobile tank 16 and the supply terminal 12. Specifically, the mobile tank control transceiver 28 transmits a unique identification code to the supply terminal control transceiver 36, which is recognized by the supply terminal transceiver 36, as being a tank matching the pre-authorized list of mobile tank 16 stored in memory of the first control transceiver 36. The supply terminal control transceiver 36 then transmits and “OK to unlock” signal back to the mobile tank control transceiver 28.

The mobile tank control transceiver 28 obtains a present position GPS signal, and compares its present position to a pre-programmed list of authorized fuel exchange locations. If the present position, as determined from the GPS reading, matches a pre-programmed authorized fluid exchange location, the lockable fluid control valve 22 at the lockable opening 20 in the mobile tank 16 is unlocked, so that the valve 22 may be manipulated to allow fluid to be pumped into the mobile tank 16.

The truck driver 56, or another operator, then attaches the fill hose 53 between the supply terminal 12 and the opening 20 in the mobile tank 16, and then opens the opening 20, by manual manipulation of a valve lever, or by pressing a button on a control panel in a valve 22 having an electric actuator 26.

After the desired volume of fuel has been transferred from the supply terminal 12 to the mobile tank 16, the opening 20 is closed, with the lever, or electric actuator 26, and the fill hose 53 is disconnected and stowed.

As the truck 18 pulls away from the supply terminal 12, it moves outside of a pre-determined GPS coordinate radius centered at the supply terminal 12. The mobile tank control transceiver 28 senses that the mobile tank 16 has moved outside of the pre-determined GPS coordinate radius, and sends a signal to the electrically actuated locking device 30 on the lockable control valve 22, to thereby cause the control valve 22 to return to its locked position.

As the mobile tank 16 is filled with fuel, the control transceivers 36, 28 in both the supply terminal 12 and the mobile tank 16 record the amount of fuel dispensed into the mobile tank 16. This data is sent to a central database, at the network operation center 44, for comparison to delivery quantities, once the mobile tank 16 returns from its delivery route.

As the truck 18 pulls the mobile tank 16 into proximity with the underground tank 14 at the service station 14, the onboard mobile tank control transceiver 28 determines, by GPS signal, whether or not the present location of the mobile tank 16 is an authorized fluid exchange location, at which the fluid control valve 22 in the lockable opening 20 of the mobile tank 16 may be unlocked.

Once the mobile tank 16 is parked adjacent the underground tank 14, the driver 56 opens ground covers in the station parking lot and connects the inductive power cable 52 from the mobile tank 16 to a fuel receptacle on a lockable fluid control valve 22, according to the invention, installed in the lockable opening 50 of the underground tank 14 at the service station. The mobile tank control transceiver 28 then communicates with another control transceiver, which is part of the lockable opening 50, of the underground tank 14, or installed at another location within the service station 14, and operatively connected by wireless link, for example to the mobile tank control transceiver 28. The mobile tank control transceiver 28, and the control transceiver at the station 14 communicate with one another and perform a mutual exchange and verification of identification codes to verify that this particular mobile tank 16 is authorized to exchange fluid with this particular underground tank 14. In some forms of the invention, the mobile tank control transceiver 28 may also verify that the present location of the mobile tank 16 is consistent with a preprogrammed authorized fluid exchange location, through use of the GPS signal 46.

Once the verification process has been successfully completed, unlock signals are sent to the lockable fluid control valves 22 located in the lockable fluid openings 20, 50 of both the mobile tank 16 and the underground tank 14.

Once the valves are unlocked, the driver 56 can connect the fuel hose 53, and deliver fuel though the fuel hose 53 to the underground tank 14. In some embodiments of the invention, having electric actuators 26 for opening the lockable fluid control valves 22 in the lockable openings 20, 50 of the mobile tank 16 and underground tank 14, initiating and stopping the exchange of fluid may be simply carried out by the operator pressing the appropriate push button on a control panel preferably attached to the mobile tank 16.

As the truck 18 pulls away from the underground tank 14 at the service station, the mobile tank control transceiver 28 monitors the GPS signal 46, and, when the mobile tank 16 has moved outside of a pre-determined GPS coordinate radius of the underground tank 14, the mobile tank control transceiver 28 sends a signal to the electric locking device 30 to relock the lockable control valve 22 of the opening 20 in the mobile tank 16. In forms of the invention where power for the lockable opening 50 in the underground tank 14 is supplied from the mobile tank 16, the invention may further include relocking the lockable opening 50 in the underground tank simultaneously with closing the lockable opening 50 in the underground tank 14, or through use of an automatic mechanical linkage, a time delay circuit, or by use of a transmitted locking signal from the mobile tank 16, or any other appropriate means, within the scope of the invention.

The volume of fluid exchanged by the mobile tank 16 at each stop along the truck's route is recorded in the mobile tank control transceiver 28, along with the GPS coordinates of each location at which fluid is exchanged. This recorded data is transmitted back to the network operation center 44, when the mobile tank 16 returns to the supply terminal 12.

Those having skill in the art will readily recognize, that although the invention has been described herein with reference to an exemplary embodiment of a given form including a single tractor trailer rig 18 transporting fluid from a supply terminal 12 to a service station 12, that other embodiments of the invention may differ substantially from the exemplary embodiment specifically described herein. It will be understood, for example, that the invention may be practiced with multiple elements, such as multiple supply terminals 12, mobile tanks 16, or service stations 14 for example, similar to any of those described above in relation to the exemplary embodiment 10. It will be further understood, that various aspects and elements of the invention may be practiced standing alone, or in combinations other than those specifically disclosed herein.

In some forms of the invention, for example, it may be desirable to utilize a grid pattern for indicating a pre-determined quadrant or area within which a lockable fill opening 20 in a mobile tank 16, according to the invention, may be opened, rather than relying on a precisely pinpointed location on the surface of the earth. For example, a quadrant or designated area encompassing a plot of ground upon which a service station 14 and its underground tanks 14 and parking lot are located may help to alleviate the necessity for parking the tractor trailer rig 18 in an exact location with respect to the underground tank 14. In the exemplary embodiment disclosed herein, the lockable openings 20, 50 in the mobile and stationary tanks are operated by a motor-driven actuator 26 and electrically activated locking device 30, which are preferably part of a lockable fluid control valve 22 at each of the respective lockable openings 20, 50. As shown in FIG. 1, a supply terminal 12, according to the invention, may also be equipped with a lockable opening 58 including a lockable fluid control valve, such as the valve 22 shown schematically in FIG. 3.

Those having skill in the art, will appreciate that, although the exemplary embodiment of the invention 10, described herein, utilized a mobile tank, in the form of a tanker truck, for shuttling fuel between a supply terminal and one or more service stations 14, that the invention may be practiced in a variety of other forms. For example, the supply terminal, mobile tank, and “service stations” may all be portable and/or moveable, in some embodiments of the invention. The tanks may take a variety of other forms, with moveable tanks used in practicing the invention having a form which can be transported by watercraft or aircraft, or in some other fashion be waterborne or airborne.

It will be further understood, by those having skill in the art, that in the exemplary embodiment of the invention 10, the mobile tank 16, represented by the trailer portion of the tractor-trailer rig 18, functions as a second tank, transporting fluid between a series of first tanks, represented by the supply terminal 12 and multiple service stations 14.

The use of the terms “a” and “an” and “the” and similar referents in the context of describing the invention is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise stated. No language in the specification should be construed as indicating any non-specified element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for controlling passage of a fluid through an opening in an otherwise substantially closed fluid tank, the method comprising, locking the opening against passage of fluid therethrough until a signal derived from a Global Positioning System (GPS) is received indicating that the tank is located at a predetermined fluid exchange position location whereat the opening in the tank is to be unlocked for allowing passage therethrough of a fluid.

2. The method of claim 1, wherein, the tank is a first tank, and the signal derived from the GPS system is received from a mobile tank located proximate to the first tank.

3. The method of claim 1, further comprising, reporting any transfer of fluid through the opening to a network operating center.

4. The method of claim 1, further comprising, reporting any locking or unlocking of the opening to a network operating center.

5. The method of claim 1, further comprising, using a motor-driven actuator for locking and unlocking the opening.

6. The method of claim 5, wherein, the tank includes the motor-driven actuator.

7. The method of claim 1, wherein the tank is a mobile tank, movable from a first location at which an unlock location designation signal input is received designating the predetermined location at which the opening is to be unlocked when a location verification signal derived from the GPS is received at the tank verifying that the mobile tank is located at the predetermined location.

8. The method of claim 7, wherein, the first location is a fluid terminal, and the method further includes an exchange of additional security codes between the terminal and the mobile tank verifying that the terminal and mobile tank are authorized to exchange fluid with one another.

9. The method of claim 8, wherein, the terminal is a supply terminal, and the only location at which the unlock designation signal to the mobile tank can be modified.

10. The method of claim 9, wherein, the unlock designation signal can only be overridden at the supply terminal.

11. The method of claim 7, wherein, a second tank also having a lockable opening therein is located at the predetermined location whereat the opening in the mobile tank can be unlocked, and the method further comprises unlocking the lockable opening in the second tank with a proximity unlock signal from the mobile tank supplied only when the mobile tank is located proximate to the second tank at the predetermined location as verified by the GPS system.

12. The method of claim 7, wherein, power for unlocking the opening in the second tank is supplied by the mobile tank through a power cable connected between the mobile tank and the lock in the second tank.

13. The method of claim 12, wherein, the proximity unlock signal is provided across an inductive link in the power cable.

14. The method of claim 11, further comprising, an exchange of an operator identification signal at the second tank, verifying that the operator is authorized to transfer fluid between the mobile tank and second tank.

15. The method of claim 14, wherein, the operator is the person transporting the mobile tank to the second tank.

16. An apparatus for controlling transfer of fluids between a first tank and a second tank, when the second tank is located at a predetermined fluid exchange location verified by receipt of a signal from a global positioning satellite (GPS), the apparatus comprising:
a lockable fluid control valve, a first control transceiver, and a second control transceiver;
the lockable fluid control valve being adapted for connection to one or the other of the first and second tanks, and configured for allowing fluid flow therethrough when in an un-locked state thereof and for blocking fluid flow therethrough when in a locked state thereof;
the first control transceiver being adapted for attachment to the first tank, and being programmable for receiving and verifying an identification code of the second control transceiver, sending an identification code of the first control transceiver, and for sending a verification signal to the second control transceiver upon verification of the identification code of the second control transceiver;
the second control transceiver being adapted for attachment to the second tank, and being programmable, for sending an identification code of the second control transceiver to the first control transceiver, and for receiving and verifying the identification code of the first control transceiver;
the second control transceiver being further programmable, for recording a desired fluid exchange GPS location, at which the second tank is allowed to exchange fluid with the first tank, for receiving a GPS signal from a source independent from the first and second control transceivers indicative of a present location of the second control transceiver, and for verifying that the present location of the second tank, as determined from the received GPS signal, matches the desired fluid exchange location;
the second control transceiver being further configured and operatively connected to the lockable fluid valve for sending an unlocking signal to the lockable fluid valve, only upon completion of a successful mutual exchange between, and mutual verification of, the programmed identification codes of the first and second control transceivers, and receipt and verification by the second control transceiver that the present GPS location of the second tank matches the programmed fluid exchange location of the second tank.

17. The apparatus of claim 16, further comprising, a network operations center (NOC), remotely locatable from the first and second control transceivers, and configured for providing the first and second control transceiver identification codes to the first and second control transceivers.

18. The apparatus of claim 16, wherein, at least one of the first and second control transceivers records an amount of fluid, if any, transferred between the first and second tanks at the fluid exchange location.

19. The apparatus of claim 18, wherein:
the apparatus further comprises a network operations center (NOC), remotely locatable from the first and second control transceivers; and
at least one of the first and second control transceivers is further configured for reporting the amount of fluid transferred to the NOC.

20. The apparatus of claim 16, wherein, the second control transceiver records a GPS location of any transfer or attempted transfer to and/or from the second tank.

21. The apparatus of claim 20, wherein:
the apparatus further comprises a network operations center (NOC), remotely locatable from the first and second control transceivers; and
at the second control transceiver is further configured for reporting a GPS location of any transfer or attempted transfer to and/or from the second tank to the NOC.

22. The apparatus of claim 16, further comprising, multiple first tanks each having a given first control transceiver operatively attached thereto, and wherein:
the second control transceiver is programmable, for sending the identification code of the second control transceiver to each of the multiple first control transceivers, and for receiving and verifying an identification code of each of the multiple first control transceivers;
the second control transceiver is also programmable, for recording multiple desired fluid exchange GPS locations, at which the second tank is allowed to exchange fluid with one or more of the multiple first tanks, for receiving a GPS signal from a source independent from the first and second control transceivers indicative of a present location of the second control transceiver, and for verifying that the present location of the second tank, as determined from the received GPS signal, matches the desired fluid exchange location of a given one of the multiple first tanks;
the second control transceiver is further configured and operatively connected to the lockable fluid valve for sending an unlocking signal to the lockable fluid valve of a given one of the first tanks at the given fluid exchange position of that one of the first tanks, only upon completion of a successful mutual exchange between, and mutual verification of, the programmed identification codes of the given one of the first control transceivers with the second control transceiver at the given fluid exchange location for that one of the first tanks, and receipt and verification by the second control transceiver that the present GPS location of the second tank matches the programmed fluid exchange location of the second tank for the given one of the multiple first tanks.

23. The apparatus of claim 22, wherein, the second control transceiver is further configured for recording and reporting any fluid transfer between the second tank and each of the first tanks.

24. The apparatus of claim 16, wherein, the second control transceiver monitors a GPS signal and re-locks the lockable fluid control valve when the second control transceiver has moved outside of a pre-determined control radius of the fluid exchange location.

25. The apparatus of claim 16, further comprising, a first lockable fluid control valve operatively attached to the first control transceiver, and a second lockable fluid control valve operatively attached to the second control transceiver, with neither the first nor the second fluid control valve being unlocked until the mutual exchange and verification of identification codes and GPS verification of the location of the second tank at a fluid exchange location has been completed.

26. The apparatus of claim 16, wherein, the second control transceiver is configured such that the identification codes and/or fluid exchange positions can only be modified when the second control transceiver is located at a designated safe-programming location.

27. The apparatus of claim 16, wherein:
the second tank is movable using a transport vehicle that includes a transport vehicle transceiver which is programmable with a transport vehicle identification code; and
the second control transponder is further programmable to allow unlocking of the fluid control valve only after further verifying that the transport vehicle identification code of the transport vehicle matches an allowable transport vehicle identification code programmed into the second control transceiver.

28. The apparatus of claim 16, wherein, one or both of the first and second control transceivers is further configured to require a proper input of an authorized operator identification code, prior to unlocking the lockable fluid control valve.

29. The apparatus of claim 16, wherein:
the fluid control valve is electrically actuated;
at least one of the first and second tanks is movable with respect to the other; and
with one of the first and second tanks includes a common electrical power source for both of the first and second control transceivers and the electrically actuated fluid control valve.

30. A computer-readable medium having computer executable instructions for performing the steps of claim 1.

31. The computer-readable medium of claim 30, wherein the tank is a mobile tank, movable from a first location at which an unlock location designation signal input is received designating the predetermined location at which the opening is to be unlocked when a location verification signal derived from the GPS is received at the tank verifying that the mobile tank is located at the predetermined location, the computer readable medium having further computer executable instructions for performing the step of verifying that the mobile tank is located at the predetermined location.

32. The computer-readable medium of claim 30, wherein, the first location is a fluid terminal, and the method further includes an exchange of additional security codes between the terminal and the mobile tank verifying that the terminal and mobile tank are authorized to exchange fluid with one another, the computer readable medium having further computer executable instructions for performing the step of verifying that the verifying that the terminal and mobile tank are authorized to exchange fluid with one another.
